(19) United States
(12) Patent Application Publication
(10) Pub. No.: US 2010/0292420 A1
(43) Pub. Date: Nov. 18, 2010

(54) CATALYST FOR THE POLYMERIZATION OF OLEFINS

(75) Inventors: Masaki Fushimi, Eschborn (DE); Martin Schneider, Hochheim (DE); Giampiero Morini, Padova (IT)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: Basell Poliolefine Italia s.r.l., Milan (IT)

(21) Appl. No.: 12/733,340

(22) PCT Filed: Aug. 19, 2008
(86) PCT No.: PCT/EP2008/060830

§ 371 Date: Jul. 26, 2010

Related U.S. Application Data
(60) Provisional application No. 60/993,271, filed on Sep. 11, 2007.

(30) Foreign Application Priority Data
Aug. 29, 2007 (EP) 07115168.2

(51) Int. Cl. C08F 4/58; C08F 4/50

(52) U.S. Cl. 526/125.3; 502/125

(57) ABSTRACT

The present invention relates to catalysts for the polymerization of ethylene and its mixtures with olefins CH₂═CHR, wherein R is an alkyl, cycloalkyl or aryl radical having 1-12 carbon atoms, comprising (A) a solid catalyst component comprising Ti, Mg, halogen, and optionally an electron donor compound in a donor/Ti molar ratio lower than 3, (B) an aluminum alkyl compound and (C) a silicon compound of formula RmSi(OEt)n in which R is C1-C20 alkyl group, m is an integer ranging from 1 to 3, n is (4-m) with the proviso that when R is equal to, or higher than, C3 m is 1 or 2. The catalyst of the invention is suitably used in (co)polymerization processes of ethylene to prepare (co)polymers having narrow Molecular Weight Distribution (MWD) and high activity.

This application is the U.S. national phase of International Application PCT/EP2008/060830, filed Aug. 19, 2008, claiming priority to European Application 07115168.2 filed Aug. 29, 2007 and the benefit under 35 U.S.C. 119(e) of U.S. Provisional Application No. 60/993,271, filed Sep. 11, 2007; the disclosures of International Application PCT/EP2008/060830, European Application 07115168.2 and U.S. Provisional Application No. 60/993,271, each as filed, are incorporated herein by reference.

The present invention relates to catalysts for the polymerization of olefins, in particular ethylene and its mixtures with olefins CH₂═CHR, wherein R is an alkyl, cycloalkyl or aryl radical having 1-12 carbon atoms, comprising a solid catalyst component comprising Ti, Mg, halogen and optionally an electron donor, an aluminum alkyl compound and a particular class of silicon compounds as external electron donor compounds. The catalysts of the invention are suitably used in (co)polymerization processes of ethylene to prepare (co)polymers having narrow Molecular Weight Distribution (MWD) and high activity. The MWD is an important characteristic of ethylene polymers in that it affects both the rheological behavior, and therefore the processability, and the final mechanical properties. In particular, polymers with narrow MWD are suitable for films and injection molding in that deformation and shrinkage problems in the manufactured article are minimized. The width of the molecular weight distribution for the ethylene polymers is generally expressed as melt flow ratio F/E, which is the ratio between the melt index measured by a load of 21.6 Kg (melt index F) and that measured with a load of 2.16 Kg (melt index E). The measurements of melt index are carried out according to ASTM D-1238 and at 190° C. Relatively low values of the said ratio indicate relatively narrow molecular weight distribution. Catalysts for preparing ethylene (co)polymers having narrow MWD are described in the European patent application EP-A-373999. The catalyst comprises a solid catalyst component consisting of a titanium compound supported on magnesium chloride, an alkyl-Al compound and an electron donor compound (external donor) selected from monoethers of the formula R′OR″. Good results in terms of narrow MWD are only obtained when the solid component also contains an internal electron donor compound (diisobutylphthalate). The catalyst activity is unsatisfactory. This latter characteristic is very important in the operation of the plants because it assures competitiveness of the production plant. Hence, it would be highly desirable to have a catalyst capable to produce polymers with narrow molecular weight distribution, in high yields.

JP 6-256413 discloses the copolymerization of ethylene with butene-1 in the presence of a catalyst comprising (A) a solid catalyst component supported on silica and comprising MgCl₂, TiCl₃ and an electron donor like tetrahydrofurane, (B) one or more aluminum alkyl compounds optionally halogenated and (C) a specific alkyl trialkoxysilane in which the alkyl is of formula —C(CH₃)₂—CH(R2)(R3) where R2 and R3 are C1-C3 hydrocarbon groups. The fact that the effect of narrowing the MWD is not particularly pronounced and that the catalyst activity is generally low, makes this catalyst system not particularly suitable for industrial use.

The applicant has now found a novel catalyst for the (co)polymerization of ethylene comprising (A) a solid catalyst component comprising Ti, Mg, halogen, and optionally an electron donor compound in a donor/Ti molar ratio lower than 3, (B) an aluminum alkyl compound and (C) a silicon compound of formula RmSi(OEt)n in which R is C1-C20 alkyl group, m is an integer ranging from 1 to 3, n is (4-m) with the proviso that when R is equal to, or higher than C3, m is 1 or 2.

A preferred subgroup of silicon compounds (C) is that in which R is C1-C4, preferably C1-C3 linear or branched alkyl, and m is 2. Preferred compounds are dimethyldiethoxysilane, diethyldiethoxysilane, di-isopropyldiethoxysilane di-n-butyldiethoxysilane. Another group of preferred silicon compound (C) are those in which R is branched alkyl having more than 3 carbon atoms, m is 1 and n is 3. Among them preferred compounds are isobutyltriethoxysilane, thexyltriethoxysilane. Cyclohexylmethyldiethoxysialne is also a usable compound.

The silicon compound (C) is used in amounts such as to give a (B)/(C) molar ratio ranging from 0.1 to 100 preferably from 1 to 50 and more preferably from 5 to 30.

In a preferred aspect the catalyst component of the invention comprises a Ti compound having at least one Ti-halogen bond supported on a magnesium chloride which is preferably magnesium dichloride and more preferably magnesium dichloride in active form. In the context of the present application the term magnesium chloride means magnesium compounds having at least one magnesium chloride bond. As mentioned before, the catalyst component may also contain groups different from halogen, in any case in amounts lower than 0.5 mole for each mole of titanium and preferably lower than 0.3.

In addition to the above characteristics, the catalysts of the invention preferably show a porosity P_{F} determined with the mercury method higher than 0.3 cm³/g and more preferably higher than 0.5 usually in the range 0.5-0.8 cm³/g. The total porosity P_{T} can be in the range of 0.50-1.50 cm³/g, particularly in the range of from 0.60 and 1.2 cm³/g, and the difference (P_{T}-P_{F}) can be higher than 0.1 preferably in the range from 0.15-0.50.

The surface area measured by the BET method is preferably lower than 80 and in particular comprised between 10 and 70 m²/g. The porosity measured by the BET method is generally comprised between 0.1 and 0.5, preferably from 0.1 to 0.4 cm³/g.

In the catalyst component of the invention the average pore radius value, for porosity due to pores up to 1 μm, is in the range from 600 to 1200 .

The particles of solid component have substantially spherical morphology and average diameter comprised between 5 and 150 μm, preferably from 20 to 100 μm and more preferably from 30 to 90 μm. As particles having substantially spherical morphology, those are meant wherein the ratio between the greater axis and the smaller axis is equal to or lower than 1.5 and preferably lower than 1.3.

The magnesium dichloride in the active form is characterized by X-ray spectra in which the most intense diffraction line which appears in the spectrum of the non active chloride (lattice distanced of 2.56 Å) is diminished in intensity and is broadened to such an extent that it becomes totally or partially merged with the reflection line falling at lattice distance (d) of 2.95 Å. When the merging is complete the single broad peak generated has the maximum of intensity which is shifted towards angles lower than those of the most intense line.

The solid the components of the invention may in principle comprise an electron donor compound (internal donor), selected for example among ethers, esters, amines and ketones. However, it has been found particularly advantageous for the present invention to include an electron donor compound only in amount such as to give ED/Ti ratios lower than 3, preferably lower than 1 and more preferably not to include any amount of electron donor compound in order for it to be absent in the final solid catalyst component (A).

The preferred titanium compounds have the formula Ti(OR″)ₙX_{y-n}, wherein n is a number comprised between 0 and 0.5 inclusive, y is the valence of titanium, R″ is an alkyl, cycloalkyl or aryl radical having 1-8 carbon atoms and X is halogen. In particular R″ can be ethyl, isopropyl, n-butyl, isobutyl, 2-ethylhexyl, n-octyl and phenyl, (benzyl); X is preferably chlorine.

If y is 4, n varies preferably from 0 to 0.02; if y is 3, n varies preferably from 0 to 0.015. TiCl₄ is especially preferred.

A method suitable for the preparation of spherical components mentioned above comprises a first step (a) in which a compound MgCl₂.mR′″OH, wherein 0.3≦m≦1.7 and R′″ is an alkyl, cycloalkyl or aryl radical having 1-12 carbon atoms is reacted with the said titanium compound of the formula Ti(OR″)ₙX_{y-n}, in which n, y, X and R″ have the same meaning defined above.

In this case MgCl₂.mR″′OH represents a precursor of Mg dihalide. These kind of compounds can generally be obtained by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Representative methods for the preparation of these spherical adducts are reported for example in U.S. Pat. No. 4,469,648, U.S. Pat. No. 4,399,054, and WO98/44009. Another useable method for the spherulization is the spray cooling described for example in U.S. Pat. Nos. 5,100,849 and 4,829,034. Adducts having the desired final alcohol content can be obtained by directly using the selected amount of alcohol directly during the adduct preparation. However, if adducts with increased porosity are to be obtained it is convenient to first prepare adducts with more than 1.7 moles of alcohol per mole of MgCl₂ and then subjecting them to a thermal and/or chemical dealcoholation process. The thermal dealcoholation process is carried out in nitrogen flow at temperatures comprised between 50 and 150° C. until the alcohol content is reduced to the value ranging from 0.3 to 1.7. A process of this type is described in EP 395083.

Generally these dealcoholated adducts are also characterized by a porosity (measured by mercury method) due to pores with radius due to pores with radius up to 0.1 μm ranging from 0.15 to 2.5 cm³/g preferably from 0.25 to 1.5 cm³/g.

In the reaction of step (a) the molar ratio Ti/Mg is stoichiometric or higher; preferably this ratio is higher than 3. Still more preferably a large excess of titanium compound is used. Preferred titanium compounds are titanium tetrahalides, in particular TiCl₄. The reaction with the Ti compound can be carried out by suspending the adduct in cold TiCl₄ (generally 0° C.); the mixture is heated up to 80-140° C. and kept at this temperature for 0.5-8 preferably from 0.5 to 3 hours. The excess of titanium compound can be separated at high temperatures by filtration or sedimentation and siphoning.

The catalyst component (B) of the invention is selected from Al-alkyl compounds possibly halogenated. In particular, it is selected from Al-trialkyl compounds, for example Al-trimethyl, Al-triethyl , Al-tri-n-butyl , Al-triisobutyl are preferred. The Al/Ti ratio is higher than 1 and is generally comprised between 5 and 800.

The above-mentioned components (A)-(C) can be fed separately into the reactor where, under the polymerization conditions can exploit their activity. It may be advantageous to carry out a pre-contact of the above components, optionally in the presence of small amounts of olefins, for a period of time ranging from 0.1 to 120 minutes preferably in the range from 1 to 60 minutes. The pre-contact can be carried out in a liquid diluent at a temperature ranging from 0 to 90° C. preferably in the range of 20 to 70° C.

The so formed catalyst system can be used directly in the main polymerization process or alternatively, it can be pre-polymerized beforehand. A pre-polymerization step is usually preferred when the main polymerization process is carried out in the gas phase. The prepolymerization can be carried out with any of the olefins CH₂═CHR, where R is H or a C1-C10 hydrocarbon group. In particular, it is especially preferred to pre-polymerize ethylene, propylene or mixtures thereof with one or more α-olefins, said mixtures containing up to 20% in moles of α-olefin, forming amounts of polymer from about 0.1 g per gram of solid component up to about 1000 g per gram of solid catalyst component. The pre-polymerization step can be carried out at temperatures from 0 to 80° C., preferably from 5 to 70° C., in the liquid or gas phase. The pre-polymerization step can be performed in-line as a part of a continuous polymerization process or separately in a batch process. The batch pre-polymerization of the catalyst of the invention with ethylene in order to produce an amount of polymer ranging from 0.5 to 20 g per gram of catalyst component is particularly preferred. The pre-polymerized catalyst component can also be subject to a further treatment with a titanium compound before being used in the main polymerization step. In this case the use of TiCl₄ is particularly preferred. The reaction with the Ti compound can be carried out by suspending the prepolymerized catalyst component in the liquid Ti compound optionally in mixture with a liquid diluent; the mixture is heated to 60-120° C. and kept at this temperature for 0.5-2 hours.

The catalysts of the invention can be used in any kind of polymerization process both in liquid and gas-phase processes. Catalysts having small particle size, (less than 40 μm) are particularly suited for slurry polymerization in an inert medium, which can be carried out continuously stirred tank reactor or in loop reactors. Catalysts having larger particle size are particularly suited for gas-phase polymerization processes which can be carried out in agitated or fluidized bed gas-phase reactors.

As already mentioned, the catalysts of the present invention are particularly suitable for preparing ethylene polymers having narrow molecular weight distribution that are characterized by a F/E ratio equal to, and preferably lower than, 30 in combination with a high polymerization activity.

In addition, to the ethylene homo and copolymers mentioned above the catalysts of the present invention are also suitable for preparing very-low-density and ultra-low-density polyethylenes (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%; elastomeric copolymers of ethylene and propylene and elastomeric terpolymers of ethylene and propylene with smaller proportions of a diene having a content by weight of units derived from ethylene of between about 30 and 70%.

The following examples are given in order to further describe the present invention in a non-limiting manner.

### CHARACTERIZATION

The properties are determined according to the following methods:

Melt Index:

Melt index (M.I.) are measured at 190° C. following ASTM D-1238 over a load of:
2.16 Kg, MI E=MI_{2.16}.
21.6 Kg, MI F=MI_{21.6}.

The ratio: F/E=MI F/MI E=MI_{21.6}/MI_{2.16} is then defined as melt flow ratio (MFR)

General Procedure for the HDPE Polymerization Test

Into a 1.5 liters stainless steel autoclave, degassed under N₂ stream at 70° C., 500 ml of anhydrous hexane, the reported amount of catalyst component and 0.17 g of triethylaluminum (TEA) were introduced (or 0.29 g of TIBA). The mixture was stirred, heated to 75° C. and thereafter 3 bar of H₂ and 7 bar of ethylene were fed. The polymerization lasted 2 hours. Ethylene was fed to keep the pressure constant. At the end, the reactor was depressurized and the polymer thus recovered was dried under vacuum at 70° C.

### EXAMPLE 1-6 AND COMPARISON EXAMPLE 1

### Preparation of the Solid Component (A)

A magnesium chloride and alcohol adduct containing about 3 mols of alcohol was prepared following the method described in example 2 of U.S. Pat. No. 4,399,054, but working at 2000 RPM instead of 10000 RPM. The adduct were subject to a thermal treatment, under nitrogen stream, over a temperature range of 50-150° C. until a weight content of 25% of alcohol was reached.

Into a 2 L four-necked round flask, purged with nitrogen, 1 L of TiCl₄ was introduced at 0° C. Then, at the same temperature, 70 g of a spherical MgCl₂/EtOH adduct containing 25% wt of ethanol and prepared as described above were added under stirring. The temperature was raised to 140° C. in 2 h and maintained for 60 min. Then, the stirring was discontinued, the solid product was allowed to settle and the supernatant liquid was siphoned off. The solid residue was then washed once with heptane at 80° C. and five times with hexane at 25° C. and dried under vacuum at 30° C. and analyzed. Into a 260 cm³ glass reactor provided with stirrer, 351.5 cm³ of hexane at 20° C. and whilst stirring 7 g of the catalyst prepared as above described were introduced at 20° C. Keeping constant the internal temperature, 5.6 cm³ of tri-n-octylaluminum (TNOA) in hexane (about 370 g/l) were slowly introduced into the reactor and the temperature was brought to 10° C. After 10 minutes stirring, 10 g of propylene were carefully introduced into the reactor at the same temperature during a time of 4 hours. The consumption of propylene in the reactor was monitored and the polymerization was discontinued when a theoretical conversion of 1 g of polymer per g of catalyst was deemed to be reached. Then, the whole content was filtered and washed three times with hexane at a temperature of 20° C. (50 g/l). After drying the resulting pre-polymerized catalyst (A) was analyzed and found to contain 1.1 g of polypropylene per g of catalyst.

The pre-polymerized solid catalyst component (A) was employed in the ethylene polymerization according to the general procedure using the type and amount of silicon compound (C) reported in table 1 together with the polymerization results.

TABLE 1

| | | Activity | | |
|---|---|---|---|---|
| EX. | Comp. C | (g/g) | MIE | F/E |
| 1 | Et₃SiOEt | 12300 | 0.6 | 30 |
| 2 | Me₂Si(OEt)₂ | 8500 | 0.23 | 28 |
| 3 | CMDES | 7050 | 0.38 | 25 |
| 4 | n-Bu₂Si(OEt)₂ | 7500 | 0.36 | 29 |
| 5 | i-Pr₂Si(OEt)₂ | 7800 | 0.39 | 26 |
| 6 | i-BuSi(OEt)₃ | 12150 | 0.47 | 29 |
| Comp. 1 | — | 14400 | 0.55 | 34 |

CMDES = Cyclohexylmethyldiethoxysilane

1. A catalyst for the (co)polymerization of ethylene comprising:
(A) a solid catalyst component comprising Ti, Mg, halogen, and optionally an electron donor compound in a donor/Ti molar ratio lower than 3; (B) an aluminum alkyl compound; and (C) a silicon compound of formula RmSi(OEt)n wherein R is a C1-C20 alkyl group, m is an integer ranging from 1 to 3, and n is (4-m), with the proviso that when R is equal to or higher than C3, m is 1 or 2.

2. The catalyst according to claim 1 wherein in the silicon compound R is a C1-C4 linear or branched alkyl, and m is 2.

3. The catalyst according to claim 2 wherein the silicon compound is selected from dimethyldiethoxysilane, diethyldiethoxysilane, di-isopropyldiethoxysilane or di-n-butyldiethoxysilane.

4. The catalyst according to claim 1 wherein the solid catalyst component (A) does not contain an internal electron donor.

5. A process for the preparation of an ethylene (co)polymer having an F/E ratio equal to or lower than 30, the process comprising polymerizing ethylene in the presence of a catalyst system comprising: (A) a solid catalyst component comprising Ti, Mg, halogen, and optionally an electron donor compound in a donor/Ti molar ratio lower than 3; (B) an aluminum alkyl compound; and (C) a silicon compound of formula RmSi(OEt)n wherein R is C1-C20 alkyl group, m is an integer ranging from 1 to 3, and n is (4-m) with the proviso that when R is equal to or higher than C3, m is 1 or 2.
